(19) United States
(12) Patent Application Publication
(10) Pub. No.: US 2026/0349907 A1
(43) Pub. Date: Nov. 5, 2026

(54) INFORMATION PROCESSING SYSTEM AND INFORMATION PROCESSING METHOD

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventor: Tadahiro TAKAZAWA, Osaka-shi, Osaka (JP)

(73) Assignees: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(21) Appl. No.: 19/115,453

(22) PCT Filed: Sep. 11, 2023
(86) PCT No.: PCT/JP2023/032981

§ 371 Date: Mar. 26, 2025

(30) Foreign Application Priority Data
Sep. 28, 2022 (JP) 2022-154982

(51) Int. Cl. G06F 11/3668

(52) U.S. Cl. CPC G06F 11/3688

(57) ABSTRACT

An information processing system includes a control unit that generates a product by integrating the source code components associated with a task, and executes a test of the task using the product. If a registration condition is satisfied, the control unit registers the product in a storage, and if the registration condition is not satisfied, the control unit does not register the product in the storage. The registration condition is at least one of; a file size of the product is less than a predetermined amount, a safety standard is higher than a predetermined level, or a difference value, obtained by a total time of a time required for registering the product in storage and a time required for reading the product from storage being subtracted from a time required for integrating the plurality of source code components, is greater than a predetermined value.

### CROSS-REFERENCE TO RELATED APPLICATIONS

This application is the U.S. national stage of PCT/JP2023/032981 filed on Sep. 11, 2023, which claims priority of Japanese Patent Application No. JP 2022-154982 filed on Sep. 28, 2022, the contents of which are incorporated herein.

### TECHNICAL FIELD

The present disclosure relates to an information processing system and an information processing method.

### BACKGROUND

Conventionally, software development is sometimes carried out using techniques called continuous integration (CI) and continuous delivery (CD). Continuous deployment (CD) is sometimes implemented instead of continuous delivery. With such development techniques, software under development is frequently subjected to automatic verification in order to suppress the occurrence of large-scale revision events and reduce cost associated with revision.

For example, at a software development site, developers individually create source code components, and the operation of each source code component is checked separately. However, when multiple source code components are integrated and run as a single piece of software, there is a risk of errors occurring. In this case, each pair of source code components needs to be verified in order to determine in which combination of components the error occurred, which may lead to a time-consuming operation test.

In development techniques that are based on CI/CD, for example, source code components individually created by developers are stored in a repository in the cloud (pushed to the repository). Each time a source code component is updated, a source code management (SCM) tool such as GitHub (registered trademark) automatically creates (builds) a task based on the source code stored in the repository. The task is automatically tested by a CI/CD tool such as Jenkins (registered trademark).

In this way, by repeatedly integrating source code components in small cycles and frequently checking for integration errors, it is possible to suppress large-scale revision.

JP 2010-134643A discloses a technology for selecting a test case to be executed based on test importance level and test execution time. In the technology of JP 2010-134643A, for example, test cases with a low importance level are not executed, thus making it possible to suppress the amount of time required for CI automatic testing.

WO 2020/166345 discloses a technology in which the results of previous tests are stored in an execution result database, and when a test is to be performed, the execution result database is first referred to, and if the result of a previous test is OK and there are no changes between the files related to the previous test and the files related to the current test, the current test is skipped. In the technology of WO 2020/166345, test-related processing can be omitted depending on the result of the determination, thus making it possible to shorten the test execution time.

Software development tends to become larger in scale every year, and as a result, the amount of time required for testing is also increasing. For this reason, when adopting a development technique that is based on CI/CD, there is demand for the ability to execute testing more efficiently.

Here, when adopting a technology in which, as in WO 2020/166345, the results of previous tests are stored in an execution result database and the results of a previous test are referred to before executing a new test to determine whether or not to skip the new test, it is necessary to create the execution result database.

However, as software development becomes larger in scale, the number of types of tests that need to be executed increases, and the size of the source files used in the tests also increases, and as a result, creating an execution result database such as that described above may take longer than executing tests without skipping, and it may not be possible to improve the efficiency of test execution.

In view of the foregoing problem, an object of the present disclosure is to provide an information processing system and an information processing method in which tests can be executed more efficiently.

### SUMMARY

An information processing system according to an aspect of the present disclosure is an information processing system for supporting development of software by executing a test of a task generated based on a plurality of source code components included in the software, the information processing system including: a control unit configured to generate a product by integrating the plurality of source code components associated with the task, and execute the test of the task using the product, wherein in a case where a registration condition is satisfied, the control unit registers the product in a storage, and in a case where the registration condition is not satisfied, the control unit does not register the product in the storage.

Here, the registration condition is at least one of first to third registration conditions, the first registration condition being that a file size of the product is less than a predetermined amount, the second registration condition being that a safety standard required for the product is higher than a predetermined level, and the third registration condition being that a difference value, which is obtained by a total time of a registration time required for registering the product in the storage and a reading time required for reading the product from the storage being subtracted from an integration time required for integrating the plurality of source code components, is greater than a predetermined value.

An information processing system according to an aspect of the present disclosure is an information processing system for supporting development of software by executing a test of a task generated based on a plurality of source code components included in the software, the information processing system including: a control unit configured to generate a product by integrating the plurality of source code components associated with the task, register the product in a storage, and execute the test of the task using the product, wherein when the task is input to the control unit, in a case where a read condition is satisfied, the control unit reads, from the storage, a corresponding product generated when the task was previously input to the control unit, and in a case where the read condition is not satisfied, the control unit generates the product based on the task currently input to the control unit.

Here, the read condition is at least one of first to third read conditions, the first read condition being that a file size of the product is less than a predetermined amount, the second read condition being that a safety standard required for the product is higher than a predetermined level, and the third read condition being that a difference value, which is obtained by a reading time required for reading the product from the storage being subtracted from an integration time required for integrating the plurality of source code components, is greater than a predetermined value.

An information processing method according to an aspect of the present disclosure is an information processing method for supporting development of software by executing a test of a task generated based on a plurality of source code components included in the software, the information processing method including: a first step of generating a product by integrating the plurality of source code components associated with the task; a second step of executing the test of the task using the product; and a third step of, in a case where a registration condition is satisfied, registering the product in a storage, and in a case where the registration condition is not satisfied, not registering the product in the storage.

Here, the registration condition is at least one of first to third registration conditions, the first registration condition being that a file size of the product is less than a predetermined amount, the second registration condition being that a safety standard required for the product is higher than a predetermined level, and the third registration condition being that a difference value, which is obtained by a total time of a registration time required for registering the product in the storage and a reading time required for reading the product from the storage being subtracted from an integration time required for integrating the plurality of source code components, is greater than a predetermined value.

### Advantageous Effects

According to the present disclosure, tests can be executed more efficiently.

### BRIEF DESCRIPTION OF DRAWINGS

FIG. 1 is a diagram illustrating an example of an information processing system according to an embodiment.

FIG. 2 is a diagram illustrating an example of software according to the embodiment.

FIG. 3 is a diagram illustrating an example of the internal configuration of an information processing device according to the embodiment.

FIG. 4 is a table showing an example of version information according to the embodiment.

FIG. 5 is a table showing an example of test result information according to the embodiment.

FIG. 6 is a table showing an example of file size information according to the embodiment.

FIG. 7 is a table illustrating an example of safety standard information according to the embodiment.

FIG. 8 is a flowchart showing an example of an information processing method according to the embodiment.

FIG. 9 illustrates a subroutine showing details of a task input process according to the embodiment.

### DETAILED DESCRIPTION OF PREFERRED EMBODIMENTS

The gist of the present disclosure includes the following configurations.

In a first aspect, an information processing system according to an aspect of the present disclosure is an information processing system for supporting development of software by executing a test of a task generated based on a plurality of source code components included in the software, the information processing system including: a control unit configured to generate a product by integrating the plurality of source code components associated with the task, and execute the test of the task using the product, wherein in a case where a registration condition is satisfied, the control unit registers the product in a storage, and in a case where the registration condition is not satisfied, the control unit does not register the product in the storage.

Here, the registration condition is at least one of first to third registration conditions, the first registration condition being that a file size of the product is less than a predetermined amount, the second registration condition being that a safety standard required for the product is higher than a predetermined level, and the third registration condition being that a difference value, which is obtained by a total time of a registration time required for registering the product in the storage and a reading time required for reading the product from the storage being subtracted from an integration time required for integrating the plurality of source code components, is greater than a predetermined value.

With this configuration, instead of unconditionally registering a product, a product is registered depending on whether or not a registration condition is satisfied, thereby making it possible to improve efficiency in terms of the time required for test execution.

In a second aspect, in the information processing system according to the first aspect, the information processing system further includes: a determination unit configured to determine whether or not the registration condition is satisfied, wherein the control unit determines whether or not to register the product in the storage, based on a determination result of the determination unit.

In a third aspect, in the information processing system according to the second aspect, in a case where an amount of free space in the storage is a first amount, the determination unit sets the predetermined amount of the first registration condition to a first predetermined amount, sets the level of the second registration condition to a first level, sets the predetermined value of the third registration condition to a first predetermined value, and determines whether or not the registration condition is satisfied, and in a case where the amount of free space in the storage is a second amount smaller than the first amount, the determination unit sets the predetermined amount of the first registration condition to a second predetermined amount smaller than the first predetermined amount, sets the level of the second registration condition to a second level higher than the first level, sets the predetermined value of the third registration condition to a second predetermined value greater than the first predetermined value, and determines whether or not the registration condition is satisfied.

The smaller the amount of free space in the storage is, the stricter the registration condition is set, thereby limiting the products to be registered to products with higher priority. This allows the remaining amount of free space in the storage to be utilized more effectively.

In a fourth aspect, in the information processing system according to any of the first through the third aspects, in a case where the registration condition is satisfied, the control unit deletes a corresponding product already registered in the storage and whose level is a first level, and registers the generated product whose level is a second level higher than the first level in the storage.

With this configuration, products with higher priority can be registered in the storage.

In a fifth aspect, in the information processing system according to any of the first through the fourth aspects, the software is software executed by an in-vehicle device for installation in a vehicle, and the safety standard is an ISO26262 Automotive Safety Integrity Level (ASIL).

In a sixth aspect, in the information processing system according to any of the first through the fifth aspects, when the task is input to the control unit, in a case where a read condition is satisfied, the control unit reads, from the storage, a corresponding product generated when the task was previously input to the control unit, and in a case where the read condition is not satisfied, the control unit generates the product based on the task currently input to the control unit.

Here, the read condition is at least one of first to third read conditions, the first read condition being that the file size of the product is less than a predetermined amount, the second read condition being that the safety standard required for the product is higher than a predetermined level, and the third read condition being that a difference value, which is obtained by the reading time required for reading the product from the storage being subtracted from the integration time required for integrating the plurality of source code components, is greater than a predetermined value.

With this configuration, instead of unconditionally reading a product, a product is read depending on whether or not a read condition is satisfied, thereby making it possible to improve efficiency in terms of the time required for test execution.

In a seventh aspect, an information processing system according to an aspect of the present disclosure is an information processing system for supporting development of software by executing a test of a task generated based on a plurality of source code components included in the software, the information processing system including: a control unit configured to generate a product by integrating the plurality of source code components associated with the task, register the product in a storage, and execute the test of the task using the product, wherein when the task is input to the control unit, in a case where a read condition is satisfied, the control unit reads, from the storage, a corresponding product generated when the task was previously input to the control unit, and in a case where the read condition is not satisfied, the control unit generates the product based on the task currently input to the control unit.

Here, the read condition is at least one of first to third read conditions, the first read condition being that a file size of the product is less than a predetermined amount, the second read condition being that a safety standard required for the product is higher than a predetermined level, and the third read condition being that a difference value, which is obtained by a reading time required for reading the product from the storage being subtracted from an integration time required for integrating the plurality of source code components, is greater than a predetermined value.

With this configuration, instead of unconditionally reading a product, a product is read depending on whether or not a read condition is satisfied, thereby making it possible to improve efficiency in terms of the time required for test execution.

In an eighth aspect, an information processing method according to an aspect of the present disclosure is an information processing method for supporting development of software by executing a test of a task generated based on a plurality of source code components included in the software, the information processing method including: a first step of generating a product by integrating the plurality of source code components associated with the task; a second step of executing the test of the task using the product; and a third step of, in a case where a registration condition is satisfied, registering the product in a storage, and in a case where the registration condition is not satisfied, not registering the product in the storage.

Here, the registration condition is at least one of first to third registration conditions, the first registration condition being that a file size of the product is less than a predetermined amount, the second registration condition being that a safety standard required for the product is higher than a predetermined level, and the third registration condition being that a difference value, which is obtained by a total time of a registration time required for registering the product in the storage and a reading time required for reading the product from the storage being subtracted from an integration time required for integrating the plurality of source code components, is greater than a predetermined value.

With this configuration, instead of unconditionally registering a product, a product is registered depending on whether or not a registration condition is satisfied, thereby making it possible to improve efficiency in terms of the time required for test execution.

Hereinafter, details of embodiments of the present disclosure will be described with reference to the drawings.

### Overall Configuration of Information Processing System

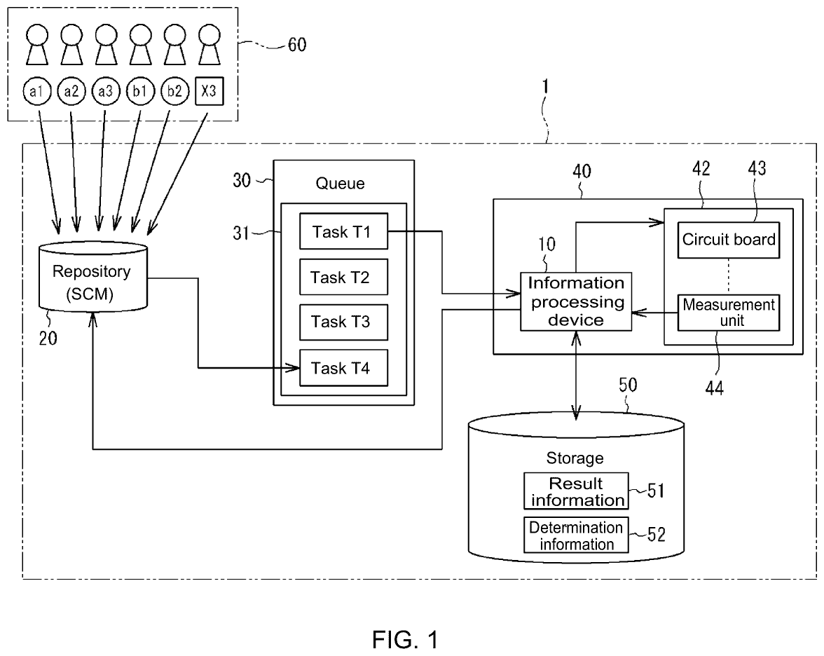

FIG. 1 is a diagram showing an example of the configuration of an information processing system 1 according to an embodiment.

The information processing system 1 is a system that supports the development of software SW1.

The software SW1 is executed in, for example, a device installed in a vehicle such as an automobile (hereinafter referred to as an “in-vehicle device”). More specifically, the software SW1 is used in an in-vehicle electronic control unit (ECU). For example, the software SW1 is used in a central ECU or an integrated ECU having a function of managing multiple ECUs. Software such as the software SW1 tends to involve large-scale development, and therefore development support provided by the information processing system 1 is particularly useful.

The information processing system 1 includes an information processing device 10, a repository 20, a test tool 30, a test environment 40, and a storage 50. The information processing system 1 may be realized by a single device (e.g., a server device) disposed at one location, or may be realized by multiple devices distributed among various locations, such as the units 10, 20, 30, 40, and 50 being connected to each other so that they can communicate with each other via a network such as the Internet.

### Software and Task

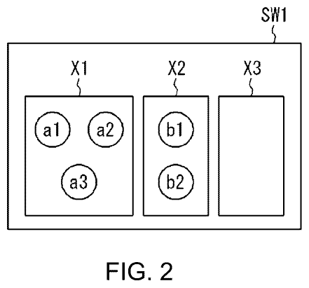

FIG. 2 is a diagram illustrating an example of the software SW1 according to the embodiment. The software SW1 and a task Tx will be described below with reference to FIG. 2. The software SW1 includes components X1, X2, and X3. The component X1 includes modules a1, a2, and a3, and the component X2 includes modules b1 and b2.

The components X1, X2, and X3 and the modules a1, a2, a3, b1, and b2 will collectively referred to as “source code components”. In other words, the software SW1 includes multiple source code components. These source code components may be data written in a certain programming language called source code, or may be data written in binary code obtained by converting source code into machine language.

For example, these source code components are created individually on multiple terminals (collectively referred to as a terminal group 60) operated by developers (suppliers). In the information processing system 1, operation testing is executed on each source code component, and operation testing is executed on each product Px generated by integrating multiple source code components. Integrating multiple source code components is sometimes called “merging” or “building”.

For example, when the modules a1, a2, and a3 are integrated, the generated product Px is the component X1. Other examples of the product Px include a product Px generated by integrating the modules a1 and a2, or a product Px generated by integrating the components X1 and X2.

Here, a test item executed in the information processing system 1 is called a task Tx. The task Tx is also called a “job task”.

The task Tx includes any one of the following test items (1) to (4).
(1) Test item for verifying operation of a module (e.g., module a1) on its own.
(2) Test item for verifying operation of a product Px that is an integration of multiple modules contained in a single component (e.g., the module al and the module a2).
(3) Test item for verifying operation of a single component (e.g., the component X1), that is, verifying operation of a product Px that is an integration of all modules contained in the component (e.g., the modules a1, a2, and a3).
(4) Test item for verifying operation of a product Px that is an integration of multiple components (e.g., the component X1 and the component X2).

In other words, a “product Px” is data generated by integrating multiple source code components, and a “task Tx” is a test item for verifying whether a single source code component or a product Px operates normally.

### Repository

Refer now to FIG. 1. The repository 20 is, for example, a database constructed in the cloud, and is realized by a mass storage device. The repository 20 is connected to the terminal group 60 via a network. Developers transmit source code components that they have created on terminals in the terminal group 60 to the repository via the network. The repository 20 stores the received source code components.

The repository 20 is accompanied by a source code management tool (also called an SCM tool) such as GitHub. The SCM automatically generates tasks Tx based on source code components stored in the repository 20. The generated tasks Tx are supplied from the repository 20 to a test tool 30.

Test Tool Refer now to FIG. 1. The test tool 30 is a CI/CD tool such as Jenkins or CircleCI (registered trademark), and is realized by a computer device that includes a processor and a memory. The test tool 30 manages a queue 31 in which a plurality of tasks Tx wait for test execution. Specifically, the test tool 30 automatically outputs the tasks Tx stored in the queue 31 to the information processing device 10 in sequence.

The queue 31 is, for example, a memory that stores tasks Tx in a first-in first-out (FIFO) manner. In the example of FIG. 1, four tasks Tx (hereinafter referred to as T1, T2, T3, and T4, when distinction between them is particularly needed) are stored in the queue 31.

FIG. 1 shows a state in which the tasks T1, T2, and T3 are already stored in the queue 31 in the stated order, and the task T4 output from the repository 20 is stored in the queue 31 at a position corresponding to last (tail position) in the order of execution. In this case, the test tool 30 outputs the tasks Tx stored in the queue 31 to the information processing device 10 in the order of the tasks T1, T2, T3, and T4.

### Information Processing Device

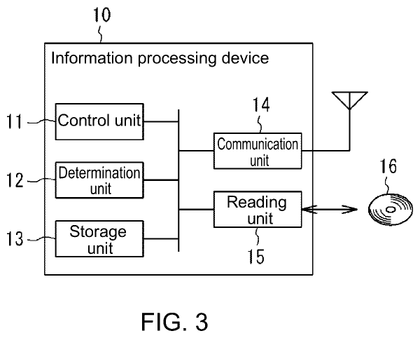

FIG. 3 is a diagram showing an example of the internal configuration of the information processing device 10 according to the embodiment. The information processing device 10 is, for example, a computer device (e.g., a laptop PC) that includes a processor and a memory, and is also called a “node”.

The information processing device 10 is a device for, upon receiving input of a task Tx from the queue 31, executing first processing for integrating source code components associated with the task Tx to generate a product Px, second processing for executing the test of the task Tx using the product Px, third processing for storing the product Px in the storage 50, and fourth processing for reading the product Px from the storage 50.

The information processing device 10 includes a control unit 11, a determination unit 12, a storage unit 13, a communication unit 14, and a reading unit 15. These units 11 to 15 are electrically connected to each other via a bus.

The control unit 11 includes circuitry such as a processor. Specifically, the control unit 11 includes one or more central processing units (CPUs). The control unit 11 reads out a computer program stored in the storage unit 13 and executes various types of calculation and control.

Note that the control unit 11 may include a processor in which a predetermined program is written in advance. For example, the control unit 11 may be an integrated circuit such as a complex programmable logic device (CPLD), a field-programmable gate array (FPGA), or an application specific integrated circuit (ASIC). In this case, the control unit 11 executes various types of calculation and control based on a program written in advance.

Similarly to the control unit 11, the determination unit 12 includes circuitry such as a processor. The determination unit 12 reads out a computer program stored in the storage unit 13 and executes various types of calculation and control. Note that similarly to the control unit 11, the determination unit 12 may be an integrated circuit. In this case, the determination unit 12 executes various types of calculation and control based on a program written in advance.

In the example of FIG. 3, the determination unit 12 is shown as a separate component from the control unit 11. However, the determination unit 12 may be integrated with the control unit 11. For example, the determination unit 12 may be a processor that shares an area with the control unit 11. Furthermore, the determination unit 12 may be included in a computer device that is separate from the information processing device 10 and connected to the information processing device 10 and the storage 50.

The storage unit 13 has a volatile memory and a non-volatile memory, and stores various types of data. One example of a volatile memory is random access memory (RAM). Examples of a non-volatile memory include a flash memory, a hard disk drive (HDD), a solid state drive (SSD), and a read only memory (ROM). The storage unit 13 stores computer programs and various parameters in, for example, a non-volatile memory.

The communication unit 14 is a communication interface that executes communication with the repository 20, the test tool 30, and the storage 50. The communication unit 14 may perform wireless communication with the units 20, 30, and 50 via a network, or may perform wired communication with them via a communication line. In the case where wireless communication is performed, the communication unit 14 has an antenna.

The reading unit 15 reads information from a computer-readable recording medium 16. The recording medium 16 is, for example, an optical disk such as a CD or a DVD, or a USB flash memory. The reading unit 15 is, for example, an optical drive or a USB terminal. A computer program and various parameters are recorded on the recording medium 16, and when the reading unit 15 reads the recording medium 16, the computer program and various parameters are stored in the non-volatile memory of the storage unit 13.

### Test Environment

Refer now to FIG. 1. The test environment 40 includes the above-described information processing device 10 and a test set 42. The information processing device 10 controls the test set 42 based on the task Tx output from the queue 31, thereby executing the test of the task Tx. Also, the information processing device 10 collects information such as the results of the test of the task Tx executed in the test set 42 (e.g., a history indicating the test execution time and whether the test was successful or failed) and outputs the collected information to the storage 50.

The test set 42 is a hardware resource that mimics the production environment in which the software SW1 operates. The software SW1 is so-called “embedded software” executed by an in-vehicle device, and therefore in order to test the operation of the software SW1, it is necessary to use a hardware resource that mimics the production environment, such as the test set 42. Specifically, the test set 42 includes a circuit board 43 and a measurement unit 44.

The circuit board 43 (also called a development board) is a board that mimics a circuit board incorporated in an in-vehicle device (e.g., a board implemented in an ECU). The circuit board 43 may be the actual circuit board that is incorporated in the in-vehicle device, or may be a prototype of the circuit board that is incorporated in the in-vehicle device. The measurement unit 44 is a tool that measures the operation of the circuit board 43. The measurement unit 44 is a communication software tool such as CANoe (registered trademark).

### Storage

The storage 50 is an auxiliary storage device such as an HDD or SSD. The storage 50 stores result information 51 and determination information 52. The result information 51 is information obtained as a result of executing the test of the task Tx. The result information 51 includes, for example, the product Px used when executing the test of the task Tx, version information D1, and test result information D2.

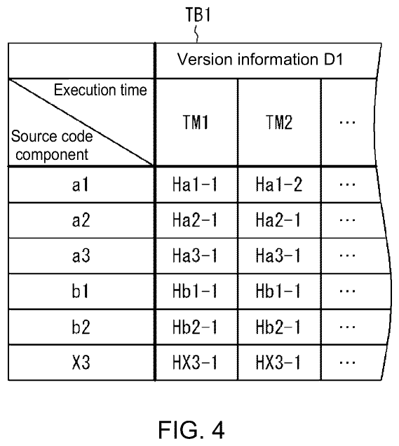

FIG. 4 is a table TB1 showing an example of the version information D1 according to the embodiment. The version information D1 is information regarding the versions of source code components at the time when the test of the task Tx was executed. The version information D1 is provided from the information processing device 10 to the storage 50, for example, every time the information processing device 10 (specifically, the control unit 11) executes the test of the task Tx. The version information D1 is shown as, for example, a hash value assigned to the source code component by the SCM (i.e., a value that is uniquely determined for the source code component).

In the example of FIG. 4, the version of the module a1 at a test execution time TM1 (e.g., the date and time when the test was executed) is shown as the hash Ha1-1, and the version of the module a2 at the execution time TM1 is shown as the hash H2-1. The version of the module a1 at an execution time TM2 later than the execution time TM1 (an execution time closer to the present time) is shown as the hash Ha1-2, and the version of the module a2 at the execution time TM1 is shown as the hash H2-1.

In other words, at the execution time TM2, the version of the module a1 had been updated from the hash Ha1-1 to the hash Ha1-2. In the example of FIG. 4, the source code components other than the module a1 are not updated between the execution time TM1 and the execution time TM2. Therefore, among the multiple source code components, the module a1 is the most recently updated source code component.

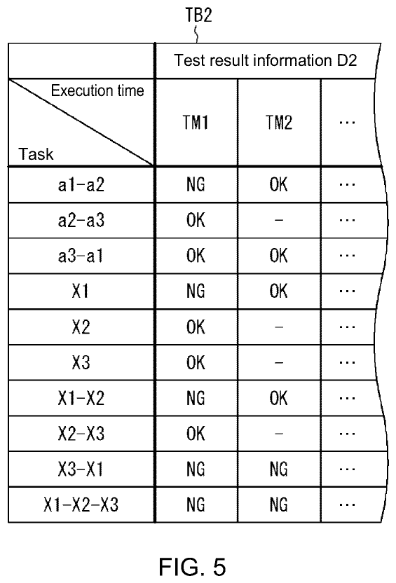

FIG. 5 is a table TB2 showing an example of the test result information D2 according to the embodiment. The test result information D2 is information in which tasks Tx are associated with the results of the tests of the tasks Tx. The test results include test failure (NG) and test success (OK). Here, a test failure includes, for example, a case where a desired measurement value condition is not met in the measurement unit 44. Also, a test success includes, for example, a case where all desired measurement value conditions are met in the measurement unit 44.

The table TB2 in FIG. 5 stores test results for each of the execution times TM1 and TM2. The test result information D2 is provided from the information processing device 10 to the storage 50, for example, every time the information processing device 10 executes the test of a task Tx. For example, it is shown that an integration test executed on the modules a1 and a2 failed at the execution time TM1 and was successful at the execution time TM2. It is also shown that an integration test executed on the modules a2 and a3 was successful at the execution time TM1, and that the integration test was not executed at the execution time TM2. Moreover, it is shown that an integration test executed on the components X3 and X1 failed at both of the execution times TM1 and TM2.

The result of the most recent test can be obtained from the test result information D2. For example, the most recent test result of the integration test executed on the modules a1 and a2 is success, and the most recent test result of the integration test executed on the modules a2 and a3 is success. In contrast, the most recent test result of the integration test executed on components X3 and X1 is failure. Furthermore, information on how many consecutive test failures have occurred in the past can be acquired from the test result information D2. For example, counting from the most recent test, the integration test executed on the components X3 and X1 has failed twice consecutively.

The determination information 52 is information for making various determinations regarding the execution of the test of the task Tx. The determination information 52 includes, for example, file size information D3, safety standard information D4, and information regarding the time required for generation, registration, and reading of the product Px.

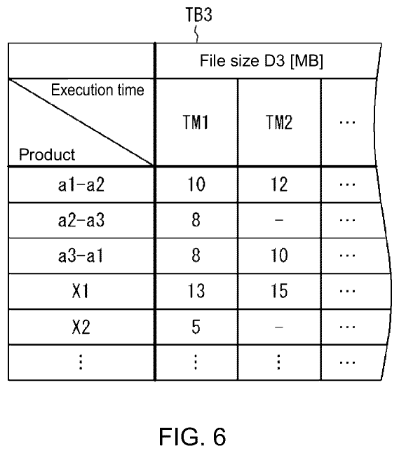

FIG. 6 is a table TB3 showing an example of the file size information D3 according to the embodiment. The file size information D3 is information regarding the file size of the product Px used in the test of the task Tx. The file size information D3 is provided from the information processing device 10 to the storage 50, for example, every time the information processing device 10 executes the test of a task Tx.

In the example of FIG. 6, it is shown that the file size of the product Px generated by integrating the modules a1 and a2 at the execution time TM1 (hereinafter referred to as the “product a1-a2”) is 10 [MB], and the file size of the product a1-a2 at the execution time TM2 is 12 [MB].

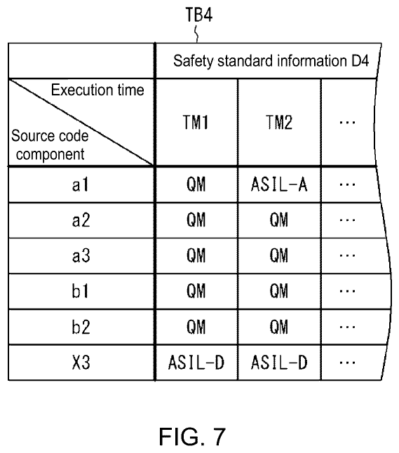

FIG. 7 is a table TB4 showing an example of the safety standard information D4 according to the embodiment. The safety standard information D4 is information regarding the safety standard required for a source code component at the time when the test of a task Tx is executed. The safety standard information D4 is provided from the information processing device 10 to the storage 50, for example, every time the information processing device 10 executes the test of a task Tx.

The safety standard is, for example, a safety standard for vehicles, more specifically, for automobiles. One example of a safety standard is ISO26262 ASIL (Automotive Safety Integrity Level). ASIL is divided into several levels, such as QM, ASIL A, ASIL-B, ASIL-C, and ASIL-D, which are in order of increasingly strict requirements. In other words, QM has the most lenient requirements and ASIL-D has the most strict requirements.

In the example of FIG. 7, the safety standard of the module a1 at the execution time TM1 is shown as QM, and the safety standard of the module a1 at the execution time TM2 is shown as ASIL-A. In other words, it is shown that the safety standard of the module a1 was raised by one level when there was the update between the execution time TM1 and the execution time TM2 (FIG. 4).

In the case of the source code components other than the module a1, there is no update between the execution time TM1 and the execution time TM2, and therefore there is no change in the safety standards. For example, the safety standard of the modules a2, a3, b1, and b2 is QM, and the safety standard of the component X3 is ASIL-D. By referring to the safety standard corresponding to the most recent execution time (the execution time TM2 in FIG. 7) in the safety standard information D4, it is possible to determine the safety standard that is currently required.

The determination information 52 includes information regarding the time required for integration of the product Px obtained by integration (integration time T1). The determination information 52 also includes information regarding the time required for registration of the product Px previously registered in the storage 50 (registration time T2). The determination information 52 also includes information regarding the time required for reading the product Px previously read from the storage 50 (reading time T3).

The integration time T1, the registration time T2, and the reading time T3 included in the determination information 52 may be values based on the actual time taken (actual measurement values or a statistical value of multiple actual measurement values), or may be predicted values. In the case of predicted values, the integration time T1, the registration time T2, and the reading time T3 are predicted based on, for example, the file size of the product Px, the communication speed of communication between the information processing device 10 and the storage 50, and the processing speed of the information processing device 10.

### Problems to Be Solved by Embodiment

The information processing system 1 includes the storage 50 (also called a build cache server) that stores a product Px (intermediate product) generated by integrating a plurality of source code components. The result information 51 is stored in a table format or the like in the storage 50 in order to manage the product Px and test results of the task Tx executed using the product Px.

When the test of a task Tx is executed in the information processing device 10, if the storage 50 is not provided, the control unit 11 generates a product Px by integrating a plurality of source code components each time a task Tx is input. However, in the control unit 11, integration of the product Px may take a long time, which may result in a long time being required for execution of the test of the task Tx.

Therefore, the information processing system 1 includes the storage 50 that stores past products Px and test results. When a task Tx is input to the control unit 11, the control unit 11 makes an inquiry to the storage 50 regarding whether or not a product Px related to the task Tx is stored, and whether or not a past test result for that product Px was success.

If the past test result is success, the control unit 11 skips the execution of the test of the input task Tx, thereby shortening the time required for test execution. Also, even in the case where the past test result was not success (the case where the test result was failure or there was no test result), if a previously integrated product Px is stored, the control unit 11 reads that product Px from the storage 50, thereby shortening the time required for integration.

In order to realize the above-mentioned shortening of time, when the control unit 11 generates a product Px by integrating a plurality of source code components, the control unit 11 stores the product Px in the storage 50. After a test is executed, the test results are stored in the storage 50.

In recent years, software development has become larger in scale, and thus the number of types of tests that are executed has increased, and the file size of the product Px used in a test has become larger. For this reason, if all products Px are stored in the storage 50, the following problems occur.
Problem 1: If the file size of the product Px is relatively large, the time required to transmit and receive the product Px between the information processing device 10 and the storage 50 becomes longer. As a result, when comparing the time required to integrate multiple source code components to generate a new product Px (integration time T1), the communication time required to register a product Px previously generated by the control unit 11 in the storage 50 (registration time T2), and the communication time required to read a product Px registered in the storage 50 to the control unit 11 (reading time T3), the sum of the two communication times (T2+T3) may be longer than the integration time (T1<T2+T3). In this case, registration of the product Px and reading of the same from the storage 50 may conversely decrease the efficiency of test execution.
Problem 2: If a larger number of products Px are registered in the storage 50, or if a product Px with a large file size is registered in the storage 50, the capacity of the storage 50 (e.g., disk capacity) may become insufficient, and it may become impossible to newly register a product Px with a relatively high priority.

In order to solve the above Problems 1 and 2, in the information processing system 1 according to the embodiment, the storage 50 further stores the determination information 52. Also, the information processing device 10 further includes the determination unit 12. When the control unit 11 receives an input of a task Tx, the determination unit 12 determines, based on the determination information 52, whether or not a new product Px is to be generated, and whether or not the newly generated product Px is to be registered in the storage 50. Based on the determination result of the determination unit 12, the control unit 11 can generate a new product Px, read out a past product Px from the storage 50, and register a generated product Px in the storage 50.

In this way, in the information processing system 1, instead of unconditionally registering all products Px in the storage 50, by determining whether or not a product Px needs to be registered depending on the situation, it is possible to improve efficiency in terms of the registration time. Furthermore, in the information processing system 1, even if a product Px is already registered in the storage 50, a new product Px may be generated depending on the situation, thereby making it possible to improve efficiency in terms of the reading time. In this way, when a development technique based on CI/CD is adopted, the information processing system 1 can reduce the time required for test execution, thereby enabling testing to be executed more efficiently.

Hereinafter, specific steps of the information processing method executed by the information processing system 1 will be described.

### Information Processing Method

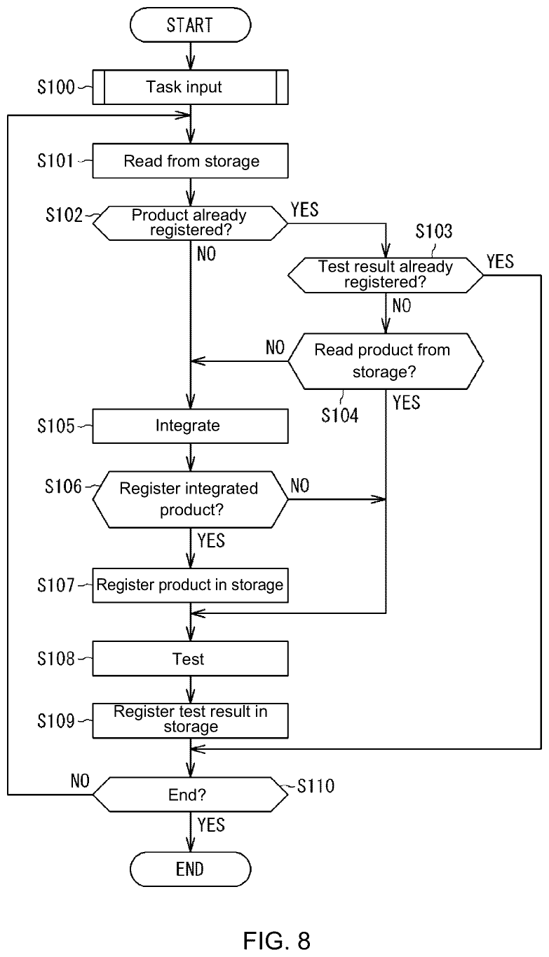

FIG. 8 is a flowchart showing an example of an information processing method executed by the information processing system 1. In the information processing system 1, first, a task Tx whose test is to be executed is input to the control unit 11 (task input process: step S100).

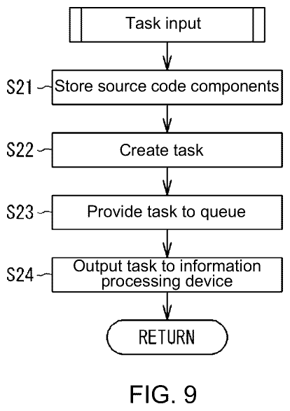

FIG. 9 is a subroutine showing the details of the task input process. First, developers create a plurality of source code components using the terminal group 60, and store the source code components in the repository 20 via the network (step S21). The source code components are stored in the repository 20 at appropriate times.

The SCM that manages the repository 20 creates a task Tx, for example, periodically (also called polling processing) or when a new source code component is stored in the repository 20 (also called push processing) (step S22). For example, if the modules a1, a2, a3, b1, and b2 and the component X3 are already stored in the repository 20, and a new version of the module a1 is then stored in the repository 20, the SCM creates tasks Tx associated with the module a1.

For example, the SCM creates a task Tx for executing an integration test on the modules a1 and a2, a task Tx for executing an integration test on the modules a1 and a3, a task Tx for executing a test on the component X1, and a task Tx for executing an integration test including the component X1 (e.g., an integration test executed on the components X1 and X2). Also, even if there are no updates to source code components, the SCM automatically creates tasks Tx for the software SW1 periodically.

Thereafter, the one or more created tasks Tx are provided by the SCM from the repository 20 to the queue 31 (step S23).

The test tool 30 outputs the tasks Tx stored in the queue 31 to the information processing device 10, for example, by the FIFO method (step S24). The communication unit 14 of the information processing device 10 outputs the task Tx received from the test tool 30 to the control unit 11. As described above, a task Tx is input to the control unit 11, and step S100 ends.

Refer now to FIG. 8. Upon receiving a new input of a task Tx, the control unit 11 reads the result information 51 from the storage 50 (step S101).

Next, the control unit 11 determines whether or not a product Px the same as a product Px obtained by integrating the source code components associated with the task Tx is registered in the storage 50 (step S102).

Specifically, the control unit 11 reads the version information D1 included in the result information 51. Then, it is determined whether or not the hash values of all the source code components associated with the input task Tx match the hash values of corresponding source code components stored in the version information D1.

If the hash values do not match for at least one source code component among all the source code components associated with the task Tx, a product Px the same as the product Px obtained by integrating the source code components associated with the task Tx is not registered in the storage 50 (NO in step S102). In other words, the product Px to be used in test execution is different from the products Px registered in the storage 50. Therefore, it is not appropriate to substitute a product Px registered in the storage 50.

For example, consider the case where, as a result of updating the module a1, a task Tx for a test item for verifying operation of a product Px obtained by integrating the modules a1 and a2 (hereinafter referred to as “task a1-a2”) is created in the SCM. In this case, for example, the module a1 has a new hash value Ha1-3. If the most recent hash value of the module a1 registered in storage 50 is “Ha1-2” as shown in FIG. 4, the hash value of the source code component included in the newly input task a1-a2 does not match the hash value of the source code component registered in storage 50, and therefore the control unit 11 determines that a product Px obtained by integrating the source code components associated with the newly input task a1-a2 is not registered in storage 50. In this case, the control unit 11 proceeds to later-described integration processing (step S105).

On the other hand, consider the case where a source code component has not been updated, and the periodically created task a1-a2 is input to the control unit 11 in the SCM. In this case, for example, the module a1 has the same hash value Ha1-2 as when the previous test was executed (execution time TM2). Moreover, the module a2 also has the same hash value Ha2-1 when compared with the execution time TM2. Accordingly, the hash values of all source code components included in the newly input tasks a1-a2 match the hash values of the corresponding source code components registered in storage 50, and therefore the control unit 11 determines that the product Px obtained by integrating the source code components associated with the newly input task a1-a2 is registered in storage 50.

If a product Px associated with the newly input task Tx is registered in the storage 50 (YES in step S102), the control unit 11 determines whether a successful test result for the input task Tx is registered in the storage 50 (step S103).

Specifically, the control unit 11 reads the test result information D2 included in the result information 51. Then, the control unit 11 checks, based on the test result information D2, whether or not the most recent test result for the newly input task Tx is success. For example, as shown in FIG. 5, the most recent test result (i.e., at the execution time TM2) for the task a1-a2 is success. In this case (YES in step S103), the control unit 11 proceeds to later-described termination determination processing (step S110), and reuses the past test result. In this case, the information processing system 1 omits the later-described integration processing (step S105) and test processing (step S108), and therefore the time required for test execution of the task Tx can be shortened.

In the test result information D2, if the most recent test result for the newly input task Tx is a failure, or if there is no past test result for the newly input task Tx (NO in step S103), the processing proceeds to the next step S104.

If the most recent test result for the newly input task Tx is not success in the test result information D2, the determination unit 12 determines, based on the determination information 52, whether or not to read the product Px from the storage 50 (step S104).

Specifically, the determination unit 12 reads the determination information 52 from the storage 50. The determination unit 12 then determines, based on the determination information 52, whether or not a read condition is satisfied for the product Px generated by integrating the source code components associated with the task Tx. Here, the read condition is at least one of the following first to third read conditions. If one of the first to third read conditions is satisfied, the determination unit 12 may determine that the read condition is satisfied. Furthermore, the determination unit 12 may determine that the read condition is satisfied only if a plurality of conditions (e.g., the first read condition and the second read condition) among the first to third read conditions are satisfied.
First read condition: the file size of the product Px stored in the storage 50 (i.e., the product Px used in the past test) is less than a predetermined amount M1
Second read condition: the safety standard required for the product Px is higher than a predetermined level L1
Third read condition: a difference value (T1−T3), which is obtained by the reading time T3 required for reading the product Px from the storage 50 being subtracted from the integration time T1 required for integrating the source code components, is greater than a predetermined value E1 (T1−T3>E1)

The determination unit 12 determines, based on the file size information D3 included in the determination information 52, whether or not the first read condition is satisfied. For example, in the case where the determination target is the product a1-a2, the determination unit 12 compares the file size of the most recent product a1-a2 (12 [MB] in the example of FIG. 6) in the file size information D3 with the predetermined amount M1. Then, if the file size of the product a1-a2 is less than the predetermined amount M1 (12<M1 [MB]), the determination unit 12 determines that the first read condition is satisfied.

If the file size of the product Px is small, the reading time T3 required for readout from the storage 50 can be kept short. Therefore, if the product Px has a file size less than the predetermined amount M1, it is determined that the first read condition is satisfied, and the product Px is read from the storage 50, thereby making it possible to prevent the reading time T3 from being long.

Here, the predetermined amount M1 may be a fixed value, or may be a value that varies depending on the situation (e.g., depending on the allowable reading time T3). For example, the predetermined amount M1 may be changed such that the longer the allowable reading time T3 is, the larger the predetermined amount M1 is. The predetermined amount M1 is stored as a parameter in the storage unit 13, for example.

The determination unit 12 determines, based on the safety standard information D4 included in the determination information 52, whether or not the second read condition is satisfied. For example, in the case where the determination target is the product a1-a2, the safety standard required for the most recent product a1-a2 is the safety standard “ASIL-A” of the module a1, which is the stricter safety standard out of the safety standards of the modules a1 and a2. In this case, the determination unit 12 compares ASIL-A with the predetermined level L1. Then, if the safety standard required for the product a1-a2 (ASIL-A) is higher than the predetermined level L1 (ASIL-A>L1), the determination unit 12 determines that the second read condition is satisfied.

A product Px with a higher safety standard also has higher standards required for testing and is more likely to fail the test. Therefore, there is a tendency for testing to be performed more frequently on a product Px that has a higher safety standard. With a configuration in which a product Px is read from the storage 50 with higher priority if the required safety standard of the product Px is higher than the predetermined level L1 and it is determined that the second read condition is met, it is possible to shorten the integration time T1 required for integrating source code components to generate the product Px.

Here, the predetermined level L1 is a level such as QM or ASIL-A. The predetermined level L1 may be a fixed value, or may be a value that varies depending on the situation. For example, the predetermined level L1 may be changed such that the longer the allowable reading time T3 is, the lower the predetermined level L1 is. The predetermined level L1 is stored as a parameter in the storage unit 13, for example.

The determination unit 12 determines, based on the times T1 and T3 included in the determination information 52, whether or not the third read condition is satisfied. For example, in the case where the determination target is the product a1-a2, the determination unit 12 compares a difference value (T1−T3), which is obtained by subtracting the reading time T3 of the product a1-a2 from the integration time T1 of the product a1-a2, with the predetermined value E1. If the difference value is greater than the predetermined value E1 (T1−T3>E1), the determination unit 12 determines that the third read condition is satisfied.

For example, if the reading time T3 is shorter than the integration time T1, the processing time can be reduced by reading the product Px from the storage 50 rather than integrating the source code components again. For this reason, with a configuration in which the product Px is read from the storage 50 with priority if the difference value (T1−T3) is larger, it is possible to shorten the time required for test execution.

Here, the predetermined value E1 may be a fixed value, or may be a value that varies depending on the situation. For example, the predetermined value E1 may be changed such that the longer the allowable reading time T3 is, the smaller the predetermined value E1 is. The predetermined value E1 is stored as a parameter in the storage unit 13, for example.

As described above, the determination unit 12 generates a determination result indicating whether or not the read condition is satisfied. The determination unit 12 then outputs the determination result to the control unit 11. If the determination result of the determination unit 12 is “read condition is satisfied”, the control unit 11 reads the product Px from the storage 50 (YES in step S104). In this case, the control unit 11 then executes later-described test processing (step S108) using the read product Px.

On the other hand, if the determination result of the determination unit 12 is “read condition is not satisfied”, the control unit 11 does not read the product Px from the storage 50 (NO in step S104). In this case, the control unit 11 generates a new product Px by integrating source code components based on the input task Tx (step S105).

After step S105, the determination unit 12 determines whether or not to register the newly generated product Px in the storage 50 (step S106). Specifically, the determination unit 12 determines, based on the newly generated product Px, whether or not a registration condition described below is satisfied. Here, the registration condition is at least one of the following first to third registration conditions.

If one of the first to third registration conditions is satisfied, the determination unit 12 may determine that the registration condition is satisfied. Furthermore, the determination unit 12 may determine that the registration condition is satisfied only if a plurality of conditions (e.g., the first registration condition and the second registration condition) among the first to third registration conditions are satisfied.
First registration condition: the file size of a new product Px generated by integrating the source code components associated with the input task Tx is less than a predetermined amount M2
Second registration condition: the safety standard required for the product Px is higher than a predetermined level L2
Third registration condition: a difference value (T1−(T2+T3)), which is obtained by the total time (T2+T3) of the registration time T2 required for registering the newly generated product Px in the storage 50 and the reading time T3 required for reading the product Px from the storage 50 being subtracted from the integration time T1 required for integrating the source code components, is greater than a predetermined value E2 (T1−(T2+T3)>E2).

For example, in the case where the determination target is the newly generated product a1-a2, the determination unit 12 compares the file size of the product a1-a2 with the predetermined amount M2. Then, if the file size of the product a1-a2 is less than the predetermined amount M2, the determination unit 12 determines that the first registration condition is satisfied.

If the file size of the product Px is small, the registration time T2 required for registration in the storage 50 can be kept short. Therefore, if the product Px has a file size less than the predetermined amount M2, it is determined that the first registration condition is satisfied, and the product Px is registered in the storage 50, thereby making it possible to prevent the registration time T2 from being long.

Here, the predetermined amount M2 may be a fixed value, or may be a value that varies depending on the situation. For example, the predetermined amount M2 may be changed such that the longer the allowable registration time T2 is, the larger the predetermined amount M2 is. The predetermined amount M2 is stored as a parameter in the storage unit 13, for example. The predetermined amount M2 may be the same as the predetermined amount M1, or may be a different value.

The determination unit 12 determines, based on the safety standard required for the product Px, whether or not the newly generated product Px satisfies the second read condition. Specifically, the determination unit 12 compares the safety standard required for the newly generated product Px with the predetermined level L2. If the safety standard required for the product Px is higher than the predetermined level L2, the determination unit 12 determines that the second read condition is satisfied.

A product Px with a high safety standard also has high standards required for testing and is more likely to fail the test. Therefore, there is a tendency for testing to be performed more frequently on a product Px that has a higher safety standard. With a configuration in which a product Px is registered in the storage 50 with higher priority if the required safety standard is higher than the predetermined level L2 and it is determined that the second registration condition is satisfied, a larger number of products Px with a high safety standard can be stored in the storage 50. Accordingly, in step S102, it is possible to improve the rate at which the product Px is registered in the storage 50 according to the input task Tx, and to reduce the frequency of integration processing and the like.

Here, the predetermined level L2 is a level such as QM or ASIL-A. The predetermined level L2 may be a fixed value, or may be a value that varies depending on the situation. For example, the predetermined level L2 may be changed such that the longer the allowable registration time T2 is, the lower the predetermined level L2 is. The predetermined level L2 is stored as a parameter in the storage unit 13, for example. Furthermore, the predetermined level L2 may be the same value as the predetermined level L1, or may be a different value.

The determination unit 12 determines, based on the times T1, T2, and T3, whether or not the third registration condition is satisfied. The determination unit 12 compares a difference value (T1−(T2+T3)), which is obtained by the total time (T2+T3) of the registration time T2 and the reading time T3 predicted to be required for the newly generated product Px being subtracted from the integration time T1 required for the product Px, with the predetermined value E2. Then, if the difference value is greater than the predetermined value E2 (T1−(T2+T3)>E2), the determination unit 12 determines that the third registration condition is satisfied.

For example, if the total time (T2+T3) is shorter than the integration time T1, registering a newly generated product Px in the storage 50 and then reading that product Px from the storage 50 can take a shorter amount of time than subsequently generating the same product Px by integrating the source code components. For this reason, with a configuration in which a product Px is registered in the storage 50 with higher priority if the difference value (T1−(T2+T3)) is large, it is possible to shorten the time required for test execution.

Here, the predetermined value E2 may be a fixed value, or may be a value that varies depending on the situation. For example, the predetermined value E2 may be changed such that the longer the allowable registration time T2 is, the smaller the predetermined value E2 is. The predetermined value E2 is stored as a parameter in the storage unit 13, for example.

As described above, the determination unit 12 generates a determination result indicating whether or not the registration condition is satisfied. The determination unit 12 then outputs the determination result to the control unit 11. If the determination result of the determination unit 12 is “registration condition is satisfied” (YES in step S106), the control unit 11 registers the newly generated product Px in the storage 50 (step S107).

On the other hand, if the determination result of the determination unit 12 is “registration condition is not satisfied” (NO in step S106), the control unit 11 skips step S107 and executes test processing (step S108). In other words, if the determination result of the determination unit 12 is “registration condition is not satisfied”, the control unit 11 does not register the newly generated product Px in the storage 50.

Next, the control unit 11 executes test processing (step S108). Specifically, the product Px read from the storage 50 or the newly generated product Px is used to execute the test of the task Tx. The control unit 11 controls the circuit board 43 based on the task Tx, and measures the operation of the circuit board 43 using the measurement unit 44. Then, based on the measurement result of the measurement unit 44, it is determined whether or not the result of the test of the task Tx is success.

After step S108, the control unit 11 registers the test result of the task Tx in the storage 50 (step S109). Test results are stored in a table format in the storage 50 as the test result information D2 shown in FIG. 5.

Lastly, the control unit 11 determines whether or not to end the series of information processing (end determination processing: step S110). Specifically, the control unit 11 determines whether or not another task Tx was input from the queue 31.

For example, in step S100, if a plurality of tasks Tx are input to the control unit 11 and the information processing from steps S101 to S109 has been executed for the first task Tx, the processing returns to step S101 (NO in step S110) to execute the information processing of steps S101 to S109 for the second task Tx. If no other task Tx to be processed has been input to the control unit 11, the series of information processing is ended (YES in step S110).

With the above, the information processing method in the information processing system 1 is completed. According to the information processing method, a product Px is not registered or read unconditionally, but rather a product Px is registered or read depending on the situation, thereby making it possible to achieve higher efficiency in terms of the time required for test execution.

### Modified Examples

Modified examples of the embodiment will be described below. In the modified examples, components the same as those in the above embodiment are denoted by the same reference numerals and descriptions thereof will be omitted.

### Considering Free Space in Storage

In step S106, the determination unit 12 may change the parameters M2, L2, and E2 in accordance with the amount of free space in the storage 50. For example, if the amount of free space in the storage 50 is a first amount C1, the determination unit 12 sets the predetermined amount M2 of the first registration condition to a first predetermined amount M21, sets the predetermined level L2 of the second registration condition to a first level L21, and sets the predetermined value E2 of the third registration condition to a first predetermined value E21, and then determines whether or not the registration condition is satisfied.

On the other hand, if the amount of free space in the storage 50 is a second amount C2 less than the first amount C1 (C2<C1), the determination unit 12 sets the predetermined amount M2 of the first registration condition to a second predetermined amount M22 less than the first predetermined amount M21, sets the predetermined level L2 of the second registration condition to a second predetermined level L22 greater than the first level L21, and sets the predetermined value E2 of the third registration condition to a second predetermined value E22 greater than the first predetermined value E21, and then determines whether or not the registration condition is satisfied (M22<M21, L22>L21, E22>E21).

In other words, the smaller the amount of free space in the storage 50 is, the stricter the registration conditions are set, thereby limiting the products Px to be registered to products Px with higher priority. This allows the remaining amount of free space in the storage 50 to be utilized more effectively.

In the above, an example is described in which all of the conditions from the first registration condition to the third registration condition are made stricter depending on the amount of free space in the storage 50. However, in accordance with the amount of free space in the storage 50, at least one of the first to third registration conditions may be made stricter. For example, a configuration is possible in which, in accordance with the amount of free space in the storage 50, the determination unit 12 sets the predetermined amount M2 of the first registration condition higher, and sets the predetermined level L2 and the predetermined value E2 of the second and third registration conditions to fixed values regardless of the amount of free space in the storage 50.

### Deletion of Product Registered in Storage

When a newly generated product Px is registered in the storage 50 in step S107, the control unit 11 may delete a product Px that is already registered in the storage 50 from the storage 50. In this case, for example, the control unit 11 allows the product Px for which a higher safety standard is required to remain in the storage 50.

Specifically, if the safety standard required for a product Px already registered in the storage 50 is the first level L21, and the safety standard required for a product Px to be newly registered is the second level L22, which is higher than the first level L21, the control unit 11 deletes the already registered product Px from the storage 50 and registers the newly generated product Px in the storage 50.

According to this configuration, for example, even if the remaining amount of free space in the storage 50 is low, higher priority products Px for which stricter safety standards are required can be registered in the storage 50.

### ADDITIONAL NOTES

This disclosure includes the content set forth in the following additional notes.

### Additional Note 1

An information processing device for supporting development of software by executing a test of a task generated based on a plurality of source code components included in the software, the information processing device including a control unit configured to generate a product by integrating the plurality of source code components associated with the task, and execute the test of the task using the product, wherein in a case where a registration condition is satisfied, the control unit registers the product in a storage, and in a case where the registration condition is not satisfied, the control unit does not register the product in the storage.

Here, the registration condition is at least one of first to third registration conditions, the first registration condition being that a file size of the product is less than a predetermined amount, the second registration condition being that a safety standard required for the product is higher than a predetermined level, and the third registration condition being that a difference value, which is obtained by a total time of a registration time required for registering the product in the storage and a reading time required for reading the product from the storage being subtracted from an integration time required for integrating the plurality of source code components, is greater than a predetermined value.

### Additional Note 2

An information processing method for supporting development of software by executing a test of a task generated based on a plurality of source code components included in the software, the information processing method including a first step of, in a case where a read condition is not satisfied, generating a product by integrating the plurality of source code components associated with the task; a second step of executing the test of the task using the product; a third step of registering the product in a storage; and a fourth step of, in a case where the read condition is satisfied, reading, from the storage, the product generated in the first step executed at a previous time.

Here, the read condition is at least one of first to third read conditions, the first read condition being that a file size of the product is less than a predetermined amount, the second read condition being that a safety standard required for the product is higher than a predetermined level, and the third read condition being that a difference value, which is obtained by a reading time required for reading the product from the storage being subtracted from an integration time required for integrating the plurality of source code components, is greater than a predetermined value.

### Additional Note 3

A computer program for supporting development of software by executing a test of a task generated based on a plurality of source code components included in the software, the computer program causing a computer to execute a first step of, in a case where a read condition is not satisfied, generating a product by integrating the plurality of source code components associated with the task; a second step of executing the test of the task using the product; a third step of registering the product in a storage; and a fourth step of, in a case where the read condition is satisfied, reading, from the storage, the product generated in the first step executed at a previous time.

Here, the read condition is at least one of first to third read conditions, the first read condition being that a file size of the product is less than a predetermined amount, the second read condition being that a safety standard required for the product is higher than a predetermined level, and the third read condition being that a difference value, which is obtained by a reading time required for reading the product from the storage being subtracted from an integration time required for integrating the plurality of source code components, is greater than a predetermined value.

### Additional Note 4

A computer program for supporting development of software by executing a test of a task generated based on a plurality of source code components included in the software, the computer program causing a computer to execute a first step of generating a product by integrating the plurality of source code components associated with the task a second step of executing the test of the task using the product; and a third step of, in a case where a registration condition is satisfied, registering the product in a storage, and in a case where the registration condition is not satisfied, not registering the product in the storage.

Here, the registration condition is at least one of first to third registration conditions, the first registration condition being that a file size of the product is less than a predetermined amount, the second registration condition being that a safety standard required for the product is higher than a predetermined level, and the third registration condition being that a difference value, which is obtained by a total time of a registration time required for registering the product in the storage and a reading time required for reading the product from the storage being subtracted from an integration time required for integrating the plurality of source code components, is greater than a predetermined value.

### Supplementary Remarks

Note that at least some of the above-described embodiments and various modified examples may be combined with each other in any desired manner. Furthermore, the embodiments and modified examples disclosed herein should be considered as illustrative in all respects and not restrictive. The scope of the present disclosure is defined by the claims, and it is intended to include all modifications within the meaning and scope equivalent to the claims.

1. An information processing system for supporting development of software by executing a test of a task generated based on a plurality of source code components included in the software, the information processing system comprising:
a control unit configured to generate a product by integrating the plurality of source code components associated with the task, and execute the test of the task using the product,
wherein in a case where a registration condition is satisfied, the control unit registers the product in a storage, and in a case where the registration condition is not satisfied, the control unit does not register the product in the storage, and
the registration condition is at least one of first to third registration conditions,
the first registration condition being that a file size of the product is less than a predetermined amount,
the second registration condition being that a safety standard required for the product is higher than a predetermined level, and
the third registration condition being that a difference value, which is obtained by a total time of a registration time required for registering the product in the storage and a reading time required for reading the product from the storage being subtracted from an integration time required for integrating the plurality of source code components, is greater than a predetermined value.

2. The information processing system according to claim 1, further including:
a determination unit configured to determine whether or not the registration condition is satisfied,
wherein the control unit determines whether or not to register the product in the storage, based on a determination result of the determination unit.

3. The information processing system according to claim 2,
wherein in a case where an amount of free space in the storage is a first amount, the determination unit sets the predetermined amount of the first registration condition to a first predetermined amount, sets the level of the second registration condition to a first level, sets the predetermined value of the third registration condition to a first predetermined value, and determines whether or not the registration condition is satisfied, and
in a case where the amount of free space in the storage is a second amount smaller than the first amount, the determination unit sets the predetermined amount of the first registration condition to a second predetermined amount smaller than the first predetermined amount, sets the level of the second registration condition to a second level higher than the first level, sets the predetermined value of the third registration condition to a second predetermined value greater than the first predetermined value, and determines whether or not the registration condition is satisfied.

4. The information processing system according to claim 1, wherein in a case where the registration condition is satisfied, the control unit deletes a corresponding product already registered in the storage and whose level is a first level, and registers the generated product whose level is a second level higher than the first level in the storage.

5. The information processing system according to claim 1,
wherein the software is software executed by an in-vehicle device for installation in a vehicle, and
the safety standard is an ISO26262 Automotive Safety Integrity Level (ASIL).

6. The information processing system according to claim 1,
wherein when the task is input to the control unit, in a case where a read condition is satisfied, the control unit reads, from the storage, a corresponding product generated when the task was previously input to the control unit, and in a case where the read condition is not satisfied, the control unit generates the product based on the task currently input to the control unit, and
the read condition is at least one of first to third read conditions,
the first read condition being that the file size of the product is less than a predetermined amount,
the second read condition being that the safety standard required for the product is higher than a predetermined level, and
the third read condition being that a difference value, which is obtained by the reading time required for reading the product from the storage being subtracted from the integration time required for integrating the plurality of source code components, is greater than a predetermined value.

7. An information processing system for supporting development of software by executing a test of a task generated based on a plurality of source code components included in the software, the information processing system comprising:
a control unit configured to generate a product by integrating the plurality of source code components associated with the task, register the product in a storage, and execute the test of the task using the product,
wherein when the task is input to the control unit, in a case where a read condition is satisfied, the control unit reads, from the storage, a corresponding product generated when the task was previously input to the control unit, and in a case where the read condition is not satisfied, the control unit generates the product based on the task currently input to the control unit, and
the read condition is at least one of first to third read conditions,
the first read condition being that a file size of the product is less than a predetermined amount,
the second read condition being that a safety standard required for the product is higher than a predetermined level, and
the third read condition being that a difference value, which is obtained by a reading time required for reading the product from the storage being subtracted from an integration time required for integrating the plurality of source code components, is greater than a predetermined value.

8. An information processing method for supporting development of software by executing a test of a task generated based on a plurality of source code components included in the software, the information processing method comprising:
a first step of generating a product by integrating the plurality of source code components associated with the task;
a second step of executing the test of the task using the product; and
a third step of, in a case where a registration condition is satisfied, registering the product in a storage, and in a case where the registration condition is not satisfied, not registering the product in the storage,
wherein the registration condition is at least one of first to third registration conditions,
the first registration condition being that a file size of the product is less than a predetermined amount,
the second registration condition being that a safety standard required for the product is higher than a predetermined level, and
the third registration condition being that a difference value, which is obtained by a total time of a registration time required for registering the product in the storage and a reading time required for reading the product from the storage being subtracted from an integration time required for integrating the plurality of source code components, is greater than a predetermined value.

9. The information processing system according to claim 2,
wherein when the task is input to the control unit, in a case where a read condition is satisfied, the control unit reads, from the storage, a corresponding product generated when the task was previously input to the control unit, and in a case where the read condition is not satisfied, the control unit generates the product based on the task currently input to the control unit, and
the read condition is at least one of first to third read conditions,
the first read condition being that the file size of the product is less than a predetermined amount,
the second read condition being that the safety standard required for the product is higher than a predetermined level, and
the third read condition being that a difference value, which is obtained by the reading time required for reading the product from the storage being subtracted from the integration time required for integrating the plurality of source code components, is greater than a predetermined value.

10. The information processing system according to claim 3,
wherein when the task is input to the control unit, in a case where a read condition is satisfied, the control unit reads, from the storage, a corresponding product generated when the task was previously input to the control unit, and in a case where the read condition is not satisfied, the control unit generates the product based on the task currently input to the control unit, and
the read condition is at least one of first to third read conditions,
the first read condition being that the file size of the product is less than a predetermined amount,
the second read condition being that the safety standard required for the product is higher than a predetermined level, and
the third read condition being that a difference value, which is obtained by the reading time required for reading the product from the storage being subtracted from the integration time required for integrating the plurality of source code components, is greater than a predetermined value.

11. The information processing system according to claim 4,
wherein when the task is input to the control unit, in a case where a read condition is satisfied, the control unit reads, from the storage, a corresponding product generated when the task was previously input to the control unit, and in a case where the read condition is not satisfied, the control unit generates the product based on the task currently input to the control unit, and
the read condition is at least one of first to third read conditions,
the first read condition being that the file size of the product is less than a predetermined amount,
the second read condition being that the safety standard required for the product is higher than a predetermined level, and
the third read condition being that a difference value, which is obtained by the reading time required for reading the product from the storage being subtracted from the integration time required for integrating the plurality of source code components, is greater than a predetermined value.

12. The information processing system according to claim 5,
wherein when the task is input to the control unit, in a case where a read condition is satisfied, the control unit reads, from the storage, a corresponding product generated when the task was previously input to the control unit, and in a case where the read condition is not satisfied, the control unit generates the product based on the task currently input to the control unit, and
the read condition is at least one of first to third read conditions,
the first read condition being that the file size of the product is less than a predetermined amount,
the second read condition being that the safety standard required for the product is higher than a predetermined level, and
the third read condition being that a difference value, which is obtained by the reading time required for reading the product from the storage being subtracted from the integration time required for integrating the plurality of source code components, is greater than a predetermined value.
